(19) United States
(12) Patent Application Publication
(10) Pub. No.: US 2025/0301283 A1
(43) Pub. Date: Sep. 25, 2025

(54) METHOD FOR CONFIGURING A LOCAL AREA NETWORK TO ALLOW WIRELESS COMMUNICATION TO BE CARRIED OUT BETWEEN MULTIPLE COMMUNICATION SETS OF MOTOR VEHICLE USERS, AND DEVICE

(71) Applicant: Continental Automotive Technologies GmbH, Hannover (DE)

(72) Inventors: Michael Rolf Meitzner, Brigachtal (DE); Patric Zimmermann, Hüfingen (DE); Stefan Bitzer, Albstadt (DE)

(73) Assignee: Continental Automotive Technologies GmbH, Hannover (DE)

(21) Appl. No.: 19/082,807

(22) Filed: Mar. 18, 2025

(30) Foreign Application Priority Data
Mar. 19, 2024 (DE) 10 2024 107 816.2

(51) Int. Cl. H04W 4/16; H04W 4/46; H04W 84/12

(52) U.S. Cl. CPC H04W 4/16; H04W 4/46; H04W 84/12

(57) ABSTRACT

The disclosure relates to a method for configuring a local area network to allow a wireless communication to be carried out between multiple communication sets of motor vehicle users, wherein the multiple communication sets are connected via a communication unit to form the local area network. The communication unit comprises a configuration memory for audio channels, at least one of which defines a voice connection between a subset, comprising at least two communication sets, of the multiple communication sets. The communication unit is connected to a motor-vehicle-based control tool conditioned for control. The method comprises receiving a selection pertaining to an audio channel from the audio channels recorded in the configuration memory on the motor-vehicle-based control tool in order to control the communication unit connected to this control tool; configuring the local area network according to the selected audio channel; carrying out the wireless communication using the selected audio channel.

### CROSS REFERENCE TO RELATED APPLICATIONS

This US patent application claims the benefit of German patent application No. 10 2024 107 816.2, filed Mar. 19, 2024, which is hereby incorporated by reference.

### TECHNICAL FIELD

The disclosure relates to a method for configuring a local area network to allow a wireless communication to be carried out between multiple communication sets of motor vehicle users. The disclosure also includes a device conditioned for operating the method for configuring such a local area network.

### BACKGROUND

Motor vehicle users are a driver and potentially at least one passenger. The term “passenger” also includes persons in a motor vehicle who are behind or in front of the driver, as may be the case with a motorcycle. Alternatively, a passenger on a motorcycle may also be referred to as a pillion passenger. As such, it may be possible for another person to ride in a sidecar of a motorcycle, for example. Communication between the users of a motor vehicle and/or, above all, users on or in different motor vehicles is at least very difficult while driving due to background noise, for example as a result of the air flowing around and/or the engine noise.

Therefore, motor vehicle users usually use communication sets to communicate with one another while driving. Such a communication set comprises at least one microphone for picking up audio signals and an earphone or headphones for outputting audio signals. The communication set may be mounted in or on the motor vehicle, potentially even on the motor vehicle user's clothing or equipment, for example on or in a motor vehicle user's helmet. For reasons of traffic safety, operation of the communication set should be such that a motor vehicle user does not have to change grip and/or turn their eyes away from the traffic situation to communicate if at all possible. Consequently, a cellphone, even if it comprises a microphone and headphones and permits communication, is not, as such, in itself suitable as a communication set while driving.

In order, then, to permit communication between multiple such communication sets while driving, the multiple communication sets are usually connected to one another to form a network in advance of driving. The network is used to forward any voice inputs captured by one of the connected communication sets to the other communication sets connected in the network.

In the description that follows, an active voice connection between communication sets is referred to as an “audio channel”, as opposed to a connection to form a local area network, which, here, is merely intended to express accessibility or “visibility” in the network for setting up such an audio channel, that is to say the allocation of a and contactability of the communication set via an ID or network address of the local area network.

Two motor vehicle users equipped with communication sets may only communicate with one another without interference as long as their distance does not exceed a maximum range, however. This maximum range is determined by the technology of the connection that is used to connect their two communication sets to one another. As such, the communication sets may be connected by means of various connection technologies, such as Bluetooth and/or WLAN, just to name some examples. If the distance between the two motor vehicle users is greater than the range predefined by their connection technology, their connection and thus also the communication will be interrupted.

Common communication sets must sometimes still be connected to a mobile radio telephone as a transmitting and/or receiving unit for telephone calls in order for motor vehicle users to be able to use it to make a telephone call while driving. A telephone call among multiple motor vehicle users each equipped with such a communication set usually requires the telephone call to be forwarded from one mobile radio telephone to the other. Based on the prior art, this is usually accomplished using intercom-specific standards, for example 802.11p. The problem in this case is that if a connection between just two of the multiple motor vehicle users is interrupted, for example because the distance between the users is too great, this usually also inevitably leads to the call between the other users being impaired or even interrupted. Additionally, motor vehicle users may only apply call settings for their own communication set.

From time to time, communication sets can also be connected to form a meshed network, also known as a mesh network. In such a meshed network, all communication sets are normally transmitters and receivers, of audio signals, that have the same permissions. By way of example, Bluetooth provides a mesh mode that combines, or connects, multiple Bluetooth devices to form a meshed radio network.

However, the disadvantage of using such mesh technology for communication between motor vehicle users is that, since all users have the same permissions, there is no central control unit on which a user may perform a configuration, e.g. to set up parallel operation of two separate audio channels. A motor vehicle user may also usually only change the setting, for example with regard to a volume level, for their own communication set. Additionally, there is at least no provision for communication among a subset of users in such a mesh network.

As such, KR 101 998 152 B1 discloses a Bluetooth intercom voice hub comprising one or more Bluetooth modules that are each connected to an intercom module including a multiplicity of ports and at least one port of the multiplicity of ports, at least one Bluetooth module of the one or more Bluetooth modules being connected to a Bluetooth headset. The technical teaching focuses on the application to communication between parties via a hub.

Similarly, KR 101 998 153 B1 discloses a Bluetooth intercom hub for shared use of information. The Bluetooth intercom information exchange hub comprises one or more Bluetooth modules that are each connected to an intercom module comprising a multiplicity of ports and at least one port of the multiplicity of ports. At least one of the Bluetooth modules is connected to a host terminal. The at least one Bluetooth module transmits a voice received from the connected host terminal to the intercom module. The intercom module passes on the relayed voice to at least some of the Bluetooth modules of the one or more Bluetooth modules.

However, neither KR 101 998 152 B1 nor KR 101 998 153 B1 reveals a control device that can be used for improved control of a hub for flexibly connecting parties.

EP 3 311 626 B1 discloses a wireless portable communication device that permits a user to conduct communication in a group. In particular, the user may use optional headphones to talk to/hear other members of the group, the communication device acting as a wireless transceiver and both transmitting the user's voice communication to the communication device of other members of the group and receiving voice communication from the other users.

EP 3 311 626 B1 does not disclose connecting multiple headphones via a central unit, on the other hand. A user therefore always needs at least one such communication device in order to be able to participate in voice communication.

U.S. Pat. No. 2,020,014 416 A1 relates to a method, a mobile phone and a system for full duplex voice or data communication in an autonomous network simultaneously with a direct connection to other communication means in other networks, so that a user may use just one audio device (e.g. a headset with or without noise control), which is connected to the mobile phone via a single port, to converse over multiple independent networks. To that end, the invention discloses a telecommunication network comprising multiple mobile phones, which, for connection, are individually connected to terminals, however.

### SUMMARY

The object of the present disclosure is to permit flexible incorporation of communication sets into a wireless communication in a user-friendly manner.

The object is achieved by the subjects of the independent patent claims. Advantageous further developments of the disclosure are described by the dependent patent claims, the description that follows and the figures.

As a solution, the disclosure proposes a method for configuring a local area network in which motor vehicle users may communicate wirelessly by means of communication sets. The communication sets are connected to a local area network via a (shared) communication unit. To that end, the communication unit may have a multiple connection, for example via one or more Bluetooth and/or WLAN interfaces. Furthermore, the communication unit is connected to a control tool, for example a motor vehicle display, for its control.

As such, the method permits a wireless communication to be carried out between multiple communication sets of motor vehicle users. “Communication” means a call between motor vehicle users using an audio channel.

According to the disclosure, multiple communication sets are therefore connected via a communication unit to form a local area network. Depending on the radio range, such a communication unit may couple the communication sets of a driver and a passenger of a shared motor vehicle to form a local area network, or even of multiple motor vehicles (a range extension for multiple motor vehicles is described later on). In other words, the multiple communication sets may be arranged in a star-shaped network topology using the communication unit, with the communication unit as the central node. In this respect, the local area network is centralized with the communication unit. The communication unit may be realized, for example, by way of a circuit board, enclosed in a housing, containing a processor circuit, a memory and a hardware-based radio interface. The memory may comprise an operating software for operating the communication unit by way of the processor circuit and/or the local area network. The operating software of the local area network may thus be updated by updating a software in the memory of the communication unit. Due to the star-shaped network topology, interruption of the connection of one of the multiple communication sets does not affect the connection between the other communication sets of the multiple communication sets and the communication unit.

The communication unit also comprises a configuration memory for audio channels. In other words, the communication unit has a memory for storing audio channel configuration data that may be used for configuring the local area network. The communication unit may thus advantageously access the stored audio channels directly and use them for configuring the local area network. This allows the communication unit to remove stored audio channels and store new audio channels in the configuration memory. It is conceivable for the configuration memory to be present in the communication unit for example as a register database of a processor circuit and/or as cache memory.

According to the disclosure, at least one audio channel of the audio channels recorded in the configuration memory defines a voice connection between all or a genuine subset, comprising at least two communication sets, of the multiple communication sets. To put it another way, there is at least one audio channel recorded in the configuration memory that permits a communication using its voice connection between all, or not all but at least two, of the multiple communication sets. It is therefore possible for an audio channel recorded in the configuration memory to define a voice connection that involves one or more motor vehicle users connected to the communication unit via their communication sets not participating in a communication and thus these one or more motor vehicle users being able to continue to concentrate on driving without disruption. By way of example, a configuration memory of a communication unit may store, for each audio channel, a connection selection that this communication unit makes after capturing an audio signal and according to which this communication unit does not forward a captured audio signal to all connected communication sets.

The inventive communication unit is connected to a motor-vehicle-based control tool conditioned for control. The motor vehicle user may control the communication unit during the wireless communication using a control element mounted on the motor vehicle without searching or changing grip. By way of example, the control tool may be connected to the motor vehicle by a cable and potentially mounted above the handlebar. As such, the control tool may be a touch display, for example, that is used to control the communication unit.

Carrying out a wireless communication between multiple communication sets of motor vehicle users in accordance with the disclosure comprises the following method steps: receiving a selection pertaining to an audio channel from the audio channels recorded in the configuration memory on the motor-vehicle-based control tool in order to control the communication unit connected to this control tool; configuring the local area network according to the selected audio channel; carrying out the wireless communication using the selected audio channel.

In other words, the motor vehicle user may, by way of input on the control tool, select an audio channel according to which the communication unit conditions or configures an applicable voice connection to permit a communication to be carried out according to this voice connection. As such, the motor vehicle user may select an audio channel flexibly and/or by way of just one movement while driving in order to connect communication sets for a communication when required. To that end, the control tool may have, for example, multiple touch- or pressure-sensitive control elements for selecting an audio channel. The communication unit may thus store a protocol or a reference to a protocol in its memory during configuration. When the communication is carried out, the protocol is potentially executed by the processor circuit in order to forward an audio signal received from the communication unit.

Another solution results from a device conditioned for operating the method. The device is used to carry out the method to configure a local area network for carrying out a wireless communication between multiple communication sets of motor vehicle users.

The disclosure also encompasses further developments that result in additional advantages.

Further developments of the method for configuring a local area network which are part of the disclosure are described below. These further developments also apply mutatis mutandis to the device conditioned for operating this method.

A further development results from the communication unit of the local area network connecting to a communication unit that is connected to further communication sets to form a further local area network, automatically or after an approval on the motor-vehicle-based control tool by a motor vehicle user, in order to offer further, cross-system audio channels for selection that permit a voice connection cross-network between the local area network and the further local area network. To put it another way, a local area network and a further local area network, both of which are connected to communication sets, may connect automatically or after approval by a motor vehicle user. Automatic connection of two local area networks, or their communication units, may take place, for example, as a result of the connection being made only after a comparison of an identifier or a key in one of the two communication units. To that end, the identifier or the key may have been exchanged for example manually or automatically during the coupling and/or reciprocal registration of the two communication units. After the connection between the communication units is set up, further cross-network audio channels are stored in the configuration memories of the two communication units. Cross-network if a further, cross-system audio channel is used to permit communication between the motor vehicle users of the local area network and the further network. The resultant advantage is that if the local area network and the further local area network part company, such automatic connection setup permits flexible reconnection of the two local area networks without, for example, interrupting the routing of audio data for an active audio channel. Preferably, for example GSM, LTE, BT, mobile radio and/or WLAN is used for the connection between the communication units. Bluetooth is also conceivable, however.

A further development results from the communication unit of the local area network being kept connected to a communication unit of a further local area network, the further local area network keeping further communication sets connected via its communication unit. In other words, the two local area networks kept interconnected may each have communication sets. Therefore, if one communication unit is not sufficient for multiple motor vehicle users to be able to communicate with one another, a second communication unit may be used. By way of example, a communication unit has a finite number, for example 2, 3, 4 . . . , 10, of Bluetooth-capable interfaces, each of which may be used to connect a communication set to the communication unit. It may therefore be that multiple communication units are necessary to connect a certain number of motor vehicle users to one another.

In addition, in one control step, the motor-vehicle-based control tool may receive a selection pertaining to a further, cross-system audio channel that defines at least one voice connection between all or a genuine subset, comprising at least two communication sets, of communication sets from the local area network and of those from the further local area network, in order to control the communication unit connected to this control tool. In other words, a motor vehicle user may select a cross-network audio channel that motor vehicle users whose communication sets are indirectly or directly connected to different communication units may use to communicate. Motor vehicle users whose sets belong to different networks may thus communicate with one another and/or with other motor vehicle users.

Furthermore, the controlled communication unit may relay configuration data pertaining to the cross-system audio channel specified by the control to the communication unit of the further local area network in order to configure the further local area network by adding at least the cross-system audio channel specified by the control to the audio channels recorded in the configuration memory of the communication unit of the further local area network. To put it another way, the configuration memory of the communication units of the local area network and of the further local area network are aligned with regard to a cross-system audio channel specified by the control. Aligning the configuration of the further local area network with the local area network permits centralized management of cross-network wireless communication. By way of example, such alignment may be performed according to a rule, for example when a selection is received and/or cyclically.

A further development results from the local area network connecting to a mobile-radio-capable mobile phone. In other words, the communication unit of the local area network may connect to a mobile-radio-capable mobile phone to receive data and/or signals from the mobile radio network and/or to relay them using the mobile radio network. The motor vehicle users may communicate, in particular make telephone calls, with persons outside the local area network in this way. Another advantage is that data, for example navigation data and/or traffic-related data, can be received from outside a local area network. A mobile-radio-capable mobile phone may be a cellphone or a tablet, for example. The mobile-radio-capable mobile phone may be connected to the communication unit via Bluetooth, for example. It is also conceivable for such a mobile-radio-capable mobile phone to provide a connection between a local area network and a further local area network.

In addition, the audio channel specified by the received selection may define at least one voice connection between all or a genuine subset of the communication sets and the mobile-radio-capable mobile phone, so that e.g. a conference call is also permitted. To put it another way, a motor vehicle user may use their control tool to select a specified audio channel that motor vehicle users whose communication sets are connected to the local area network can use to communicate with persons outside a local area network. As such, for example motor vehicle users in the local area network can communicate with another person via an LTE connection while driving.

In a further development of the disclosure, carrying out the wireless communication using the selected audio channel comprises the following steps of capturing an audio signal from one of the multiple communication sets connected by the audio channel and forwarding the audio signal to the communication unit connected to this communication set; processing the audio signal in the communication unit connected to this communication set and determining the connection defined by the selected audio channel; forwarding the processed audio signal to the communication sets specified according to the connection based on the audio channel.

In other words, motor vehicle users may use their communication set to relay voice inputs (vocal utterances) to other communication sets connected to a communication unit, where they are output as a voice signal. The communication unit processes the audio signal received by way of the voice input and forwards the processed audio signal to the communication sets according to the previously selected audio channel. This results in the advantage that the communication unit, as a central unit, always controls the implementation of the communication. By way of example, processing the audio signal may comprise encryption and/or applying a modulation method and/or an audio encoding method according to a protocol used for forwarding. It is also conceivable for the communication unit to carry out further configurations pertaining to the local area network, for example withholding the audio signal or mixing multiple audio signals, when processing the audio signal.

A further development results from, while the wireless communication is being carried out using the selected audio channel, a different communication simultaneously being carried out using a different audio channel of the audio channels of the controlled communication unit that are recorded in the configuration memory than the selected audio channel. In other words, a communication unit may simultaneously receive, process, and forward two audio signals, each relating to a different wireless communication according to a different audio channel, separately from one another. This results in the advantage that two calls, each of the calls corresponding to a communication that is being carried out, may take place in one local area network simultaneously. By way of example, one motor vehicle driver may converse with their passenger using a first audio channel while another motor vehicle driver is simultaneously communicating with their passenger using the same communication unit.

A further development results from the motor-vehicle-based control tool, as a motor vehicle display, displaying motor-vehicle-specific and/or communication-specific data and receiving the selection pertaining to the audio channel. To put it another way, a motor vehicle display may serve as a control tool on which motor-vehicle-specific and/or communication-specific data are displayed. To that end, the motor vehicle display may have sensors and/or control elements that the motor vehicle user uses to select the audio channel. This results in the advantage that the control tool is space-saving and within reach in the tool area of the motor vehicle. By way of example, the motor vehicle display can have a speed indicator and/or gas indicator and/or oil indicators and/or other motor vehicle settings, and also a touch screen for selecting an audio channel. It is also conceivable for the control tool to comprise a device by means of which a motor vehicle user may select the audio channel using a voice input.

A further development results from the controlled communication unit receiving predetermined audio signals relating to at least traffic-related information via the connected control tool, and the controlled communication unit having recorded in its configuration memory at least one audio channel that is used to output such predetermined audio signals to a specified set of connected communication sets. In other words, the communication unit may be configured such that predetermined audio signals relating to at least traffic-related information received via the control tool are forwarded to a set of the connected communication sets automatically or on the basis of an input. This permits one or more motor vehicle users to adapt their driving on the basis of traffic-related information. By way of example, this allows a motor vehicle user, without losing sight of their traffic situation, to use congestion and/or weather reports during driving to avoid delays and/or dangerous traffic circumstances. Such predetermined audio signals are potentially automatically or manually forwarded to all communication sets in the local area network using a broadcast function immediately after receiving the predetermined audio signals. Which audio signals are predetermined may be defined and/or changed by a configuration setting pertaining to the communication unit, for example.

A further development results from the respective motor vehicle provided being a two-wheeled motor vehicle, a three-wheeled motor vehicle, a four-wheeled light vehicle and/or a motorized watercraft. To put it another way, the motor vehicles used belong to one or more of the classes of motor vehicles having two or three wheels, or to the class of four-wheeled light vehicles or to motorized watercraft. By way of example, a quad belongs to the class of four-wheeled light vehicles. A jet ski is in turn an example of a motorized watercraft. Examples of two-wheeled motor vehicles are in particular a motorcycle or moped. In particular, the set of two- and three-wheeled motor vehicles, and also four-wheeled light vehicles and/or motorized watercraft, includes all motor vehicles in EU vehicle classes (European Union vehicle classes) L1 to L7.

For carrying out the steps described, the communication unit and/or the control tool may potentially contain a processor circuit, each of which potentially comprises programming or software, comprising program instructions, that causes the processor circuits to carry out an embodiment of the method when executing the program instructions. To that end, each of the processor circuits may have at least one microprocessor and/or microcontroller. Each of the program instructions may be stored in a data memory of the processor circuit.

For use cases or application situations that may arise for the method and are not explicitly described here, there may be provision for the method to involve an error message and/or a request for input of user feedback being output and/or a default setting and/or a predetermined initial state being set.

The disclosure also includes the combinations of the features of the embodiments described.

### BRIEF DESCRIPTION OF THE DRAWINGS

Embodiments of the disclosure are described below. In this respect:

FIG. 1 shows a communication unit connected to communication sets, and also connected to a control element and a mobile-radio-capable mobile phone, to form a local area network; and

FIG. 2 shows two interconnected communication units, each connected to communication sets to form a local area network.

### DETAILED DESCRIPTION

The embodiments explained below are preferred embodiments of the disclosure. In the embodiments, the described components of the embodiments are each individual features of the disclosure that may be considered independently of one another, which each also refine the disclosure independently of one another and may therefore also be regarded as a component of the disclosure individually or in a combination other than that shown. Furthermore, the described embodiments may also be supplemented by further features of the disclosure from among those that have already been described. In the figures, functionally identical elements are each provided with the same reference signs.

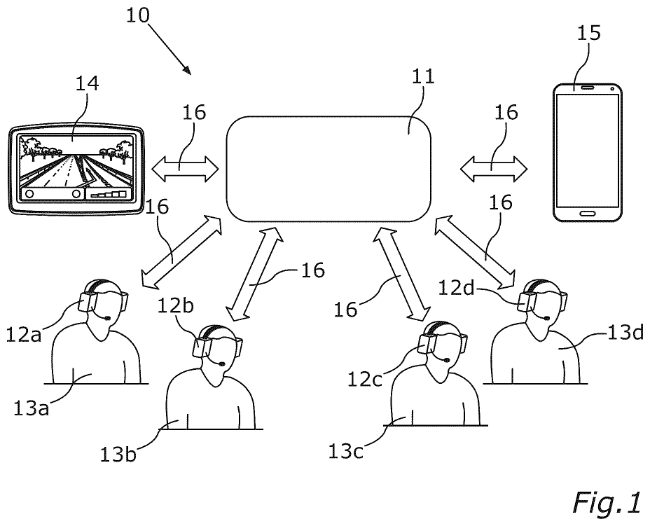

FIG. 1 shows an embodiment having multiple communication sets 12a, 12b, 12c, 12d of motor vehicle users 13a, 13b, 13c, 13d that are connected 16 via a communication unit 11 to form a local area network 10. The communication unit 11 is also connected 16 to a motor-vehicle-based control tool 14 and a mobile-radio-capable mobile phone 15.

In this case, a motor vehicle user 13a, 13b, 13c, 13d may be a driver of a motor vehicle or their passenger. By way of example, each of the motor vehicle users 13a, 13c may be the driver of a motor vehicle and the motor vehicle users 13b,13d may be their passengers, for example.

The communication unit 11 may have one or more input elements that a motor vehicle user may use to make a direct input for controlling the communication unit 11. The communication unit 11 may be operated using a battery and/or a rechargeable battery. Otherwise, the communication unit 11 may also be supplied with power by a motor vehicle via a possible connection, for example using the control tool 14, and/or its rechargeable battery can be charged. The communication unit 11 acts as a central unit in carrying out a communication, thus simplifying troubleshooting and updating of the local area network 10. Moreover, interruption of the connection, for example of one of the connected communication sets 12a, 12b, 12c, 12d, has no effect on the connection of the other devices 12a, 12b, 12c, 12d, 14, 15 to the communication unit 11. Connection of further devices, for example a communication set 12a, 12b, 12c, 12d or a mobile-radio-capable mobile phone 15, to the communication unit 11 only requires a connection to be made between the new device and the communication unit 11 in addition.

As already described above, the motor-vehicle-based control tool 14 of the local area network 10 may be used to control the communication unit 11. As such, the motor-vehicle-based control tool 14 may, for example, be a motor vehicle display and/or integrated in a motor vehicle display. However, it is also conceivable for the control tool 14 to be connected to the motor vehicle via a detachable interface. In that case, the control tool 14 may potentially be disconnected from the motor vehicle for maintenance and/or repair work. The motor vehicle users 13a, 13b, 13c, 13d may potentially also use a mobile-radio-capable mobile phone 15 to receive data and/or signals from persons outside the local area network 10 and to relay them to persons outside the local area network 10.

The individual connections 16 in the local area network 10 may be the same everywhere, but are preferably partly different. As such, it is conceivable for one or more of the connections 16 to use potentially different Bluetooth specifications, potentially WLAN or other connections suitable for transmitting signals. Some or all of the connections 16 may also be through cable connections. The connections 16 between the communication sets 12a, 12b, 12c, 12d and the communication unit 11 may be energy-saving, for example in the case of Bluetooth LE, to permit a communication to be carried out on an ongoing basis and robustly. In turn, the connection 16 between the communication unit 11 and one or more devices, for example the mobile-radio-capable mobile phone 15, may be in a form such that even though a motor vehicle user 13a, 13b, 13c, 13d does not carry the one or more devices directly on their person while driving, but rather, for example, carries it/them in a side pocket and/or in a seat shell of the motor vehicle, a connection 16 to these one or more devices is possible. This is particularly advantageous when there is a lack of space, and also increases safety while driving, since none of the motor vehicle users 13a, 13b, 13c, 13d may be distracted directly by the connected device in the side pocket.

A motor vehicle user 13a, 13b, 13c, 13d may use an input on the control tool 14 to select an audio channel. The audio channel may, as already described above, define a voice connection between all or a genuine subset, comprising at least two communication sets, of motor vehicle users 13a, 13b, 13c, 13d. As such, the audio channel may permit a voice connection for example between two motor vehicle users, such as the motor vehicle user 12a and the motor vehicle user 12b. Alternatively, it may permit a communication between all motor vehicle users 13a, 13b, 13c, 13d, for example. A voice connection may define a connection that all or even just a subset, but at least two, of the motor vehicle users 13a, 13b, 13c, 13d may use to communicate, even though all motor vehicle users 13a, 13b, 13c, 13d, or their communication sets 12a, 12b, 12c, 12d, are potentially connected simultaneously.

The selection on the control tool 14, and the subsequent control of the communication unit 11, may be the cause of a configuration of the local area network 10 on the basis of the selected audio channel. The configuration of the local area network 10 may result in a voice connection being defined, for example in a hardware-based and/or software-based manner, according to the selected audio channel. This definition may comprise, for example, determining and/or storing addresses relating to the communication sets 12a, 12b, 12c, 12d defined in the voice connection. Such an address may be provided, for example, on the basis of a name, for example the Bluetooth name, and/or an identifier, for example an MAC address. As such, defining the configuration connection as part of the configuration of the local area network 10 may comprise for example storing one or more of the addresses relating to the communication sets 12a, 12b, 12c, 12d defined in the voice connection in a memory area upstream of the processor circuit, in order to permit rapid access to the selected voice connection during further operation of the communication unit. According to the selected addresses, digitized audio samples of audio signals from the communication sets may be routed in the communication unit, resulting in an audio channel between the communication sets.

It is possible for a local area network 10 to simultaneously have multiple configurations relating to different selected audio channels. By way of example, in a first selection, a first set of addresses may be stored in a memory. In the case of a further selection, it is possible for a second set of addresses relating to the further selection to be stored in the memory, the first set being able to be removed from the memory beforehand or potentially remaining in the memory.

The communication unit 11 may, alternatively or additionally, potentially receive predetermined audio signals relating to traffic-related information via the control tool 14 and/or the mobile-radio-capable mobile phone 15. The audio signals may be predetermined if a motor vehicle user 13a, 13b, 13c, 13d has potentially preselected, for example using the control tool, which audio signal is a predetermined audio signal. Alternatively or additionally, however, the communication unit 11 may also have a setting according to which audio signals received during operation of the communication unit 11, for example traffic radio and/or weather radio and/or incoming audio signals from the mobile radio network, to name just a few as examples, are always classified as predetermined audio signals by the communication unit 11. It is also conceivable for a received audio signal to carry an identifier by way of which a communication unit 11 classifies the received audio signal as a predetermined audio signal. In any case, the communication unit 11 may potentially have, in its configuration memory, an audio channel according to which the communication unit, on receiving such a predetermined audio signal, outputs the predetermined audio signal to a predetermined set of connected communication sets 12a, 12b, 12c, 12d. It is conceivable for the communication unit 11, even without receiving a selection pertaining to such a channel, but on the basis of reception of such a predetermined audio signal, to configure the local area network 10 according to an audio channel associated with the predetermined audio signal with the aim of the received predetermined audio signal being immediately forwarded, on reception, to a predetermined set of connected communication sets 12a, 12b, 12c, 12d. As such, incoming traffic reports, for example congestion reports or telephone calls, may be automatically forwarded by the communication unit 11 to a set of the motor vehicle users 13a, 13b, 13c, 13d, for example the drivers among the motor vehicle users 13a, 13b, 13c, 13d, without delay to ensure improved and safe driving. The communication unit 11 may potentially have, in its configuration memory, an audio channel for notification according to which a notification signal, for example an emergency signal, is sent. The notification may be forwarded for example to an emergency station via a potentially connected mobile-radio-capable mobile phone 15 and/or at least to the other communication sets 12a, 12b, 12c, 12d. The communication unit 11 is potentially able to take circumstances, for example an accident detected by sensors on a motor vehicle, as a basis for sending such a notification signal by means of an audio channel automatically and/or on receiving an applicable selection. The notification signal potentially even includes coordinates from the accident site. As such, the communication unit is potentially used not only for carrying out communication, but also simultaneously as an emergency system for motor vehicle users while driving.

As such, after the local area network 10 has been configured, a communication may take place according to the audio channel selected by way of the input. Such a communication involves audio signals, provided for example by one of the motor vehicle users 13a, 13b, 13c, 13d and captured by their communication set 12a, 12b, 12c, 12d, being forwarded to the other communication sets 12a, 12b, 12c, 12d scheduled according to the selected audio channel. For example, if the communication set 12a captures an audio signal from motor vehicle user 13a and the local area network 10 is configured such that there is a voice connection according to which motor vehicle user 12a and motor vehicle user 12c are connected for communication, the audio signal received by the communication unit from motor vehicle user 12a is forwarded to motor vehicle user 12c after it has been processed. To that end, the captured audio signal can first be forwarded to the communication unit 11 and processed by the communication unit 11. As already described above, processing of the audio signal may include, for example, unpacking and/or decoding the audio signal and/or mixing multiple captured audio signals. It is also conceivable for the communication unit 11 to apply a filter for removing background noise when processing the audio signal, so that the processed audio signal has less unwanted background noise than the captured audio signal. The communication sets 12a, 12b, 12c, 12d may additionally or alternatively also have such a filter, whether hardware- or software-based is another matter, for reducing unwanted background noise. Such reduction of unwanted background noise in a captured and/or received audio signal advantageously leads to improved and safer communication between the motor vehicle users 13a, 13b, 13c, 13d.

The local area network 10 may also have multiple configurations. Thus, two audio signals, each captured, potentially even simultaneously, by different communication sets 12a, 12b, 12c, 12d, may, after parallel processing in one and the same communication unit 11, be forwarded to communication sets 12a, 12b, 12c, 12d according to different configurations. As such, for example a first audio signal captured from motor vehicle user 13a by the communication set 12a may be forwarded according to a first voice connection relating to a first configuration in the local area network 10, after processing in the communication unit 11, to the communication set 12d of the motor vehicle user 13d, and simultaneously a second audio signal captured from the motor vehicle user 13b by the communication set 12b may be forwarded according to a first voice connection relating to a first configuration in the local area network 10, after processing in the communication unit 11, to the communication set 12c of the motor vehicle user 13c. Consequently, the communication unit 11 may process and forward multiple received audio signals simultaneously, potentially according to different configuration of the local area network 10. As such, a communication unit 11 may control and permit the implementation of multiple communications simultaneously.

As already described above, the communication unit 11 may also connect 16 to a mobile-radio-capable mobile phone 15. Connection to the mobile-radio-capable mobile phone 15 allows the audio channels potentially already recorded in the configuration memory of the communication unit 11 to be supplemented by further specified audio channels. By way of example, the motor vehicle user 13a may use the control tool 14 to select an audio channel with a voice connection according to which motor vehicle users 13a and 13c speak to a person who is not in the local area network using the communication unit 11 and by means of the mobile-radio-capable mobile phone 15. The communication unit 11 may also use the mobile-radio-capable mobile phone to receive data and/or signals, which may potentially be received directly or, when required, from one or more motor vehicle users 13a, 13b, 13c, 13d via their communication sets 12a, 12b, 12c, 12d. By way of example, a call from a person outside the local area network can arrive on the mobile-radio-capable mobile phone 15 connected to the communication unit 11, whereupon one or more motor vehicle users 13a, 13b, 13c, 13d are informed thereof. By selecting an audio channel, for example using the control tool 14, one of the motor vehicle users 13a, 13b, 13c, 13d may then accept the telephone call for communication. The motor vehicle user accepting the telephone call for communication potentially selects an audio channel according to which a voice connection between one or more of the motor vehicle users 13a, 13b, 13c, 13d and the mobile-radio-capable mobile phone 15 is defined for communication.

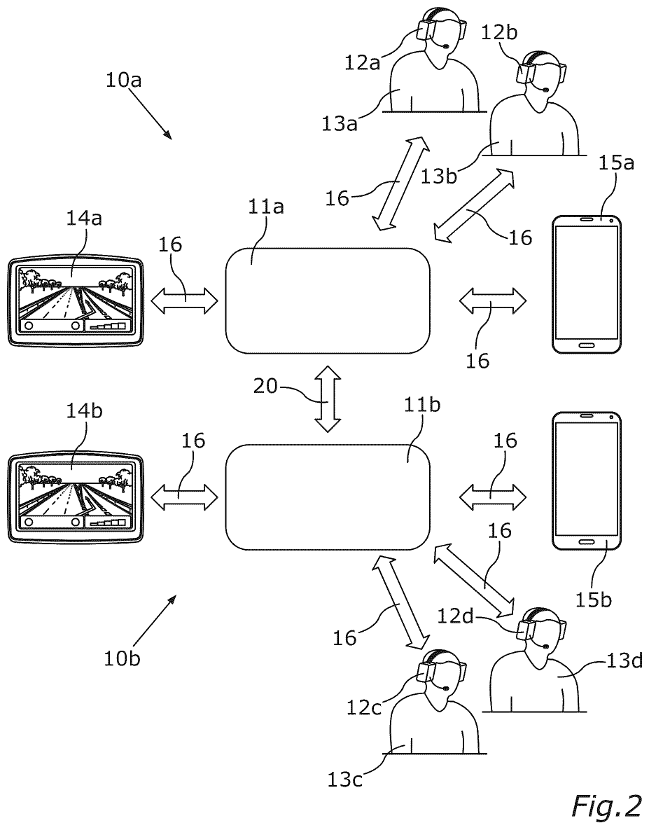

FIG. 2 shows an exemplary embodiment with two local area networks 10a, 10b that may use a connection 20 to exchange audio signals and/or data between the associated communication units 11a, 11b of the local area networks 10a, 10b.

A first communication unit 11a is connected to two communication sets 12a, 12b of motor vehicle users 13a, 13b and to a first control element 14a, and also potentially to a first mobile phone 15a, to form a first local area network 10a. A second communication unit 11b is connected to communication sets 12c, 12d of motor vehicle users 13c, 13d and to a second control element 14b, and also potentially to a second mobile phone 15b, to form a second local area network 10b.

The connection 20 between the first and second communication units 11a, 11b is used for exchanging data and/or signals between the two local area networks 10a, 10b and, as already described, may be set up automatically or by way of approval from a motor vehicle user 13a, 13b, 13c, 13d. By way of example, the communication unit 11a and the communication unit 11b may approach one another such that one of the two or both communication units 11a, 11b automatically relay an identifier to the other communication unit for checking. If the check is positive, a connection is set up between the communication units 11a, 11b, otherwise it is not. It is also conceivable for automatic connection setup to take place without a check. Thus, the communication units 11a, 11b of two local area networks 10a, 10b can flexibly connect to one another. Communication among a multiplicity of motor vehicle users 13a, 13b, 13c, 13d whose communication sets 12a, 12b, 12c, 12d are connected to two different communication units 11a, 11b is thus possible even then if the distance between the communication units 11a, 11b of their two local area networks 10a, 10b permits the communication units 11a, 11b to automatically connect.

As already described above, it may be that the communication units 11a, 11b, as a result of such connection setup between the two local area networks 10a, 10b, record further, cross-system audio channels in their configuration memories. A voice connection relating to such a cross-system audio channel can, for example, permit communication between motor vehicle users 13a, 13b, 13c, 13d. Such a cross-system audio channel would also be provided by a cross-network voice connection between at least one of the mobile-radio-capable mobile phones 15a, 15b and all or one, but at least two, of the communication sets 12a, 12b, 12c, 12d. By way of example, the motor vehicle user 13d from the second local area network 10b and the motor vehicle user 13b in the first local area network could use the connection 20 between the communication units 11a, 11b, and the mobile-radio-capable mobile phone 15a, to hold a telephone call with a person outside the two local area networks 10a and 10b. The motor vehicle users 13a, 13b, 13c, 13d may thus select such a cross-system audio channel, for example using an input on one of the two control tools 14a, 14b. The selection controls the directly adjacent communication unit 11a, 11b. Thus, if for example the motor vehicle user 13a uses the control tool 14a to select a cross-system audio channel, potentially initially only the communication unit 11a is controlled and configured. If there is a connection between the first and second communication units 11a, 11b, the first communication unit 11a can relay the selected cross-system audio channel to the second communication unit 11b to perform an alignment between the first network 10a and the second network 10b.

A particularly preferred embodiment is described below: Drivers of motorcycles, jet skis or quads, and also generally of vehicles in vehicle classes L1 to L7, usually connect their headsets directly to a mobile telephone. There is a direct connection between the headset and the mobile telephone. No other entity is involved. In this case, it is only possible to connect a maximum of one headset to the mobile telephone. The use of multiple headsets on a mobile telephone is not usually supported.

The prior art therefore has the following disadvantages, inter alia: only one headset may be coupled to a mobile telephone; a passenger, for example a pillion passenger, or multiple other parties cannot be included in the call without initiating forwarding of the call to other mobile devices.

Consequently, the object is to permit flexible incorporation of further parties to a call into an existing voice connection.

The solution therefore comprises a communication unit 11, 11a, 11b, also referred to as a CIB (Connected Infotainment Box), which initiates a connection (using Bluetooth Classic, optionally also using WiFi) to the mobile telephone, also referred to as a mobile-radio-capable mobile phone 15, 15a, 15b, and further connections to various headsets, also called communication sets 12a, 12b, 12c, 12d, using Bluetooth Low Energy (LE Audio) and/or Bluetooth EDR/BR (classic). The CIB mixes and switches the various audio channels and routes them to the mobile telephone. Furthermore, it is thus also possible to hold calls among one another, without a mobile telephone.

Resulting advantages of the solution are as follows: drivers, passengers and other parties, for example the motor vehicle users 12a, 12b, 12c, 12d, may connect to a mobile telephone and hold a joint telephone call; a group call with only one mobile telephone is possible, especially for physically separate parties; easy connection setup; user guidance using a central unit possible.

The present disclosure is intended for use in quads or small motorized vehicles with low complexity and also off-road, agricultural and forestry vehicles (e.g. EU vehicle classes such as L, M, N, O, T, C . . . ).

In one embodiment, the CIB consists of at least one Bluetooth Classic module and a Bluetooth Low Energy module according to the 5.2 standard or later, which supports the optional LE Audio as central and peripheral feature. First, a Bluetooth connection is established between the CIB and the mobile telephone. The classic audio profiles are used for communication. The headset(s) is/are also connected to the CIB. This connection uses LE Audio and potentially also classic Bluetooth profiles for transmission. The CIB is used as a central node to convert, switch and mix the signals.

In another exemplary embodiment, there is the possibility of using the central node (CIB) to connect a group of persons (in this case a motorcyclist group) to one another and permit a group call. Such communication systems have to date been produced using 802.11p and are proprietary. The patent-pending approach is based on a given standard and is not a proprietary solution. Commercially available headsets that support LE Audio can be used. The interlocutors are always controlled and approved via the CIB. Furthermore, the CIB may be used to forward music or audio and navigation announcements to all parties in the group.

Overall, the example shows how audio signals and/or infotainment data for motorcycles may be provided for motorcycles via multiple headsets on motorized two-wheelers on a mobile telephone using a CIB.

1. A method, the method comprising:
configuring a local area network to allow a wireless communication to be carried out between multiple communication sets of motor vehicle users, wherein the multiple communication sets are connected via a communication unit to form the local area network, and wherein the communication unit comprises a configuration memory for audio channels, and wherein at least one audio channel of the audio channels recorded in the configuration memory defines a voice connection between all or a genuine subset, comprising at least two communication sets, of the multiple communication sets, the communication unit being connected to a motor-vehicle-based control tool conditioned for control,
receiving a selection pertaining to an audio channel from the audio channels recorded in the configuration memory on the motor-vehicle-based control tool in order to control the communication unit connected to this control tool,
configuring the local area network according to the selected audio channel, and
carrying out the wireless communication using the selected audio channel.

2. The method as claimed in claim 1, wherein the communication unit of the local area network is kept connected to a communication unit of a further local area network, the further local area network keeping further communication sets connected via its communication unit.

3. The method as claimed in claim 1, wherein the communication unit of the local area network connects to a further communication unit, by way of which further communication sets are connected to form a further local area network, automatically or after an approval given on the motor-vehicle-based control tool by a motor vehicle user, in order to offer further, cross-system audio channels for selection that provide for a voice connection cross-network between the local area network and the further local area network.

4. The method as claimed in claim 2, wherein the motor-vehicle-based control tool receives a selection pertaining to a further, cross-system audio channel that defines at least one voice connection between all or a genuine subset, comprising at least two communication sets, of communication sets from the local area network and also of those from the further local area network, in order to control the communication unit connected to this control tool.

5. The method as claimed in claim 4, wherein the controlled communication unit relays the cross-system audio channel specified by the control to the communication unit of the further local area network in order to configure the further local area network by adding at least the cross-system audio channel specified by the control to the audio channels recorded in the configuration memory of the communication unit of the further local area network.

6. The method as claimed in claim 1, wherein the local area network connects to a mobile-radio-capable mobile phone.

7. The method as claimed in claim 6, wherein the audio channel specified by the received selection defines at least one voice connection between all or a genuine subset of the communication sets and the mobile-radio-capable mobile phone.

8. The method as claimed in claim 1, wherein carrying out the wireless communication using the selected audio channel comprises:
capturing an audio signal from one of the multiple communication sets connected by the audio channel and forwarding the audio signal to the communication unit connected to this communication set;
processing the audio signal in the communication unit connected to this communication set and determining the voice connection defined by the selected audio channel; and
forwarding the processed audio signal to the communication sets specified according to the voice connection defined by the selected audio channel.

9. The method as claimed in claim 1, wherein while the wireless communication is being carried out using the selected audio channel, a different communication is carried out using a different audio channel of the audio channels of the controlled communication unit that are recorded in the configuration memory than the selected audio channel.

10. The method as claimed in claim 1, wherein the motor-vehicle-based control tool, as a motor vehicle display, displays motor-vehicle-specific and/or communication-specific data and receives the selection pertaining to the audio channel.

11. The method as claimed in claim 1, wherein the controlled communication unit receives predetermined audio signals relating to at least traffic-related information via the connected control tool, and the controlled communication unit has recorded in its configuration memory at least one audio channel that is used to output such predetermined audio signals to a specified set of connected communication sets.

12. The method as claimed in claim 1, wherein the respective motor vehicle used is a two-wheeled motor vehicle, a three-wheeled motor vehicle, a four-wheeled light vehicle and/or a motorized watercraft.

13. A device, the device comprising:
at least one control tool,
communication sets, and
at least one communication unit, wherein the at least one communication unit is conditioned for configuring a local area network for carrying out a wireless communication between multiple communication sets of motor vehicle users, wherein the communication sets are connected via the at least one communication unit to form the local area network, wherein the at least one communication unit comprises a configuration memory for audio channels, and wherein at least one audio channel of the audio channels recorded in the configuration memory defines a voice connection between all or a genuine subset, the at least one communication unit being connected to the motor-vehicle-based control tool, the device being configured to perform operations, comprising:
receiving a selection pertaining to an audio channel from the audio channels recorded in the configuration memory on the motor-vehicle-based control tool in order to control the communication unit connected to the control tool,
configuring the local area network according to the selected audio channel, and
carrying out the wireless communication using the selected audio channel.

14. A motor vehicle containing a control tool and a communication unit containing a configuration memory for audio channels, which the communication unit is conditioned for configuring a local area network for carrying out a wireless communication between multiple communication sets of motor vehicle users, wherein the multiple communication sets are connected via the communication unit to form the local area network, wherein the communication unit is connected to the motor-vehicle-based control tool, the motor vehicle being configured to perform operations, comprising:
receiving a selection pertaining to an audio channel from the audio channels recorded in a configuration memory on the motor-vehicle-based control tool in order to control the communication united connected to the control tool,
configuring the local area network according to the selected audio channel, and
carrying out the wireless communication using the selected audio channel.
